(19) United States
(12) Patent Application Publication
(10) Pub. No.: US 2013/0159088 A1
(43) Pub. Date: Jun. 20, 2013

(54) PROVIDING OFFERS THAT SPECIFY A VARIABLE DISCOUNT WITH RESPECT TO A PRICE OF A GOOD AND/OR SERVICE

(71) Applicant: Kaushal Kurapati, Cupertino, CA (US)

(72) Inventor: Kaushal Kurapati, Cupertino, CA (US)

(73) Assignee: YAHOO! INC., Sunnyvale, CA (US)

(21) Appl. No.: 13/332,056

(22) Filed: Dec. 20, 2011

(51) Int. Cl. G06Q 30/02

(52) U.S. Cl. 705/14.35

(57) ABSTRACT

Techniques are described herein for providing discounted offers for goods and/or services. In one example, the discounted offer may specify a variable discount. In an aspect of this example, an amount of the variable discount may decrease for each customer or group thereof who accepts the offer. In accordance with this aspect, customer(s) who accept the offer earlier than other customers may be given a greater discount. In another aspect, the amount of the discount may vary for successive predetermined time intervals. For instance, the amount of the variable discount may be greater for customer(s) who accept the offer during a predetermined time interval that occurs earlier than another predetermined time interval. Accordingly, the amount of the discount may decrease for temporally successive predetermined time intervals. In both aspects, once a specified number of customers accept the discounted offer, the discounted offer may thereafter specify a fixed discount.

### BACKGROUND OF K INVENTION

1. Field of the Invention

The present invention relates to providing discounted offers for goods and/or services over a computer network.

2. Background

Group buying, also known as collective buying, is a sales technique in which goods and/or services are offered for purchase at a reduced price on condition that a minimum number of buyers make the purchase. Historically, a group of potential buyers would negotiate deals with local merchants. Each deal would be essentially to deliver a crowd of customers in exchange for a substantial discount on the goods and/or services of the merchant. Accordingly, group buying typically assures the merchant of a relatively large group of customers, as well as exposure and advertisement of the merchant's brand and/or business, while the group of customers receives sizable discounts on the goods and/or services.

More recently, group buying has become more prevalent in e-commerce. Group-buying websites and services that use discounted deals as the core for their business are becoming increasingly common and thus are becoming major players in the online shopping industry. Typically, these websites and services feature a deal of the day, with the deal being activated once a set number of customers agree to buy a specified good or service. If enough customers sign up for the deal, the customers get the discount. Conversely, if the set number of customers is not reached, the deal is cancelled, and the customers who agreed to buy the good or service are not charged for the deal.

One drawback to such a sales technique is that if the deal is cancelled due to an insufficient number of customers accepting the deal, the customers who accepted the deal are unable to take advantage of the discount regarding the good and/or service. Moreover, the company offering the deal loses out on the potential business (e.g., referrals, repeat customers, the sale of additional goods and/or services, etc.) generated from such customers.

### BRIEF SUMMARY OF THE INVENTION

Various approaches are described herein for, among other things, providing discounted offers for goods and/or services. A discounted offer is an offer that specifies a discount with respect to a price of a good and/or service. The discounted offer may be represented as a coupon, a gift certificate, etc. In one example, the discounted offer may specify a variable discount. In an aspect of this example, an amount of the variable discount may decrease for each customer (or group of customers) who accepts the offer. In accordance with this aspect, customer(s) who accept the offer earlier than other customers may be given a greater discount. In another aspect, the amount of the discount may vary for successive predetermined time intervals. For instance, the amount of the variable discount may be greater for customer(s) who accept the offer during a predetermined time interval that occurs earlier than another predetermined time interval in which the discounted offer is provided. Accordingly, the amount of the discount may decrease for temporally successive predetermined time intervals. In both aspects, once a specified number of customers accept the discounted offer, the discounted offer may thereafter specify a fixed discount.

An example method is described in which first instances of an offer are provided. The first instances specify a variable discount with respect to a price of good(s) and/or service(s). An amount of the variable discount is reduced for each successive subset of the first instances. Each subset of the first instances includes one or more of the first instances. First acceptances of the offer are received. Each of the first acceptances corresponds to a respective first instance. A determination is made whether a number of the first acceptances reaches a threshold. The reducing of the amount of the variable discount is discontinued in response to determining that the number of the first acceptances reaches the threshold. Thereafter, second instances of the offer are provided. The second instances specify a fixed discount with respect to the price of the good(s) and/or service(s).

Another method is described. In accordance with this method, first instances of an offer are provided. The first instances specify a variable discount with respect to a price of good(s) and/or service(s) among predetermined time interval(s). Each predetermined time interval corresponds to a respective subset of the first instances. Each subset of the first instances includes one or more of the first instances. An amount of the variable discount is reduced upon expiration of each of the predetermined time interval(s). A final predetermined time interval is determined. Second instances of the offer are provided during a time period that follows the final predetermined time interval. The second instances specify a fixed discount with respect to the price of the good(s) and/or service(s).

A system is described that includes provision logic, reduction logic, and determination logic. The provision logic is configured to provide first instances of an offer. The first instances specify a variable discount with respect to a price of good(s) and/or service(s). The reduction logic is configured to reduce an amount of the variable discount for each successive subset of the first instances. Each subset of the first instances includes one or more of the first instances. The determination logic is configured to determine whether a number of first acceptances of the offer reaches a threshold. Each of the first acceptances corresponds to a respective first instance. The reduction logic is further configured to discontinue reduction of the amount of the variable discount to provide a fixed discount in response to a determination that the number of the first acceptances reaches the threshold. The provision logic is further configured to provide second instances of the offer in response to discontinuation of the reduction of the amount of the variable discount. The second instances specify the fixed discount with respect to the price of the good(s) and/or service(s).

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example deal system in accordance with an embodiment described herein.

FIGS. 2 and 5 depict flowcharts of example methods for providing instances of an offer specifying a variable discount in accordance with embodiments described herein.

FIGS. 3 and 4 depict flowcharts of example methods for discontinuing provision of instances of an offer having a fixed discount in accordance with the embodiment described with respect to FIG. 2.

FIG. 6 depicts a flowchart of an example method for discontinuing provision of instances of an offer specifying a variable discount during a designated predetermined time interval in accordance with the embodiment described with respect to FIG. 5.

FIGS. 7 and 8 depict flowcharts of example methods for discontinuing provision of instances of an offer specifying a variable discount in accordance with the embodiment described with respect to FIG. 5.

FIGS. 9 and 10 depict flowcharts of example methods for discontinuing provision of instances of an offer specifying a fixed discount in accordance with the embodiment described with respect to FIG. 5.

FIG. 11 is a block diagram of an example implementation of a differential deal discount engine shown in FIG. 1 in accordance with an embodiment described herein.

FIG. 12 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Example embodiments are capable of providing discounted offers for goods and/or services. A discounted offer is an offer that specifies a discount with respect to a price of a good and/or service. The discounted offer may be represented as a coupon, a gift certificate, etc. In one example, the discounted offer may specify a variable discount. In an aspect of this example, an amount of the variable discount may decrease for each customer (or group of customers) who accepts the offer. In accordance with this aspect, customer(s) who accept the offer earlier than other customers may be given a greater discount. In another aspect, the amount of the discount may vary for successive predetermined time intervals. For instance, the amount of the variable discount may be greater for customer(s) who accept the offer during a predetermined time interval that occurs earlier than another predetermined time interval in which the discounted offer is provided. Accordingly, the amount of the discount may decrease for temporally successive predetermined time intervals. In both aspects, once a specified number of customers accept the discounted offer, the discounted offer may thereafter specify a fixed discount.

Techniques described herein have a variety of benefits as compared to conventional techniques for providing discounted offers. For instance, the techniques described herein may allow a merchant to set a number of acceptances needed to activate a deal that corresponds to a discounted offer to be relatively high (in order ensure a minimum volume of customers), while ensuring that enough customers will accept the discounted offer. This may be achieved by providing the discounted offer to specify a variable discount, such that customers who accept the offer relatively early are given a greater discount than customers who accept the offer at a later time. By incentivizing customers to accept the discounted offer earlier rather than later, a greater number of acceptances may be achieved due to the customers' opportunity of securing a greater discount. Such an incentive may increase a likelihood that the deal will be activated.

While the techniques described herein may be implemented by any type of merchant, merchants that provide services where the incremental costs of providing the services to additional customers are relatively low may benefit more from the techniques described herein than other merchants. Consider, for example, a merchant such as a concert organizer. Regardless of the number of customers attending the concert, the performers of the concert expend the same energy and time. Thus, the cost for holding a concert for 100 people as compared to holding a concert for 1000 people may be virtually the same. Accordingly, the return on investment may increase substantially if more customers attend the concert. On the other hand, if relatively few customers attend the concert, the concert organizer may lose money by holding the concert. By implementing the techniques described herein, the concert organizer can ensure that a profit is achieved by holding the concert only if a specified number of customers have purchased tickets to the concert.

### II. Example Embodiments

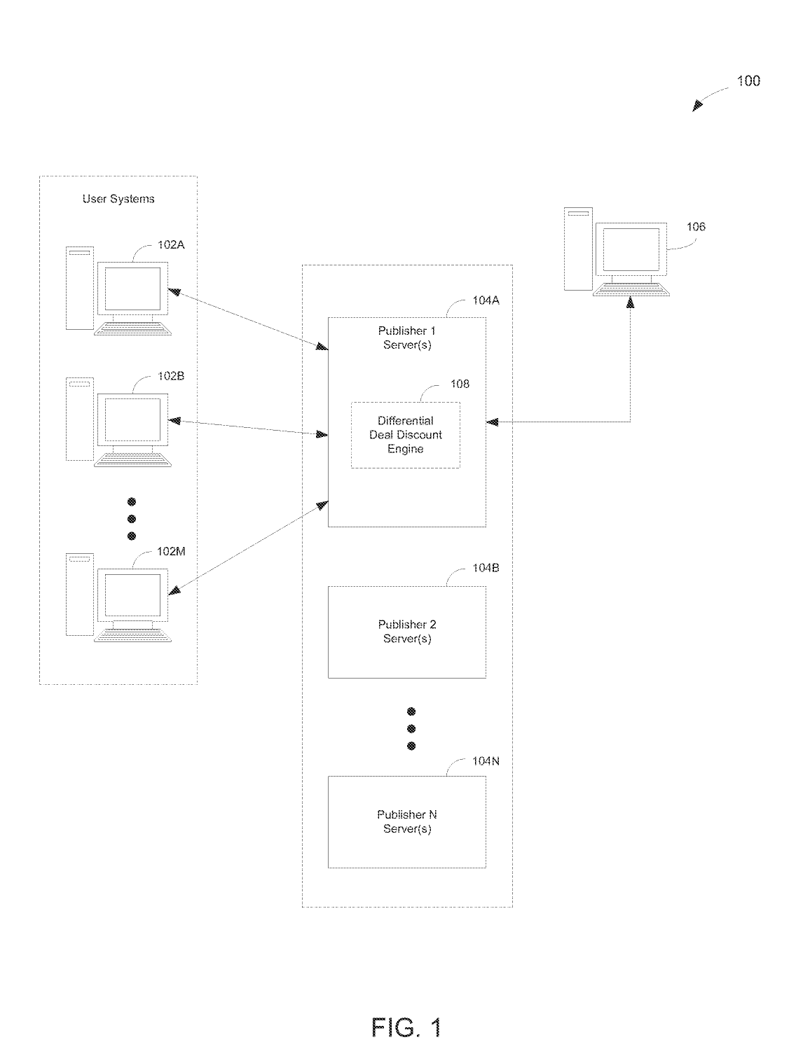

FIG. 1 is a block diagram of an example deal system 100 in accordance with an embodiment described herein. Generally speaking, deal system 100 operates to serve deals (i.e., discounted offers, such as coupons, gift certificates, etc.) provided by merchants (e.g., sellers of products and/or services) to sites (e.g., Web sites) published by publishers when such sites are accessed by certain users of the network, thereby delivering the deals to the users. In example embodiments, the discount offered for a specified good and/or service may be claimed only if a specified number of customers accept the deal. Once the specified number of customers accept the deal, the deal is activated, and each customer who accepted the deal receives the discount. However, if fewer than the specified number of customers accept the deal, then the deal is not activated (i.e., the deal is canceled), in which case none of the customers receive the discount.

As shown in FIG. 1, deal system 100 includes a plurality of user systems 102A-102M, a plurality of publisher servers 104A-104N, and at least one merchant system 106. Communication among user systems 102A-102M, publisher servers 104A-104N, and merchant system 106 is carried out over a network using well-known network communication protocols. The network may be a wide-area network (e.g., the Internet), a local area network (LAN), another type of network, or a combination thereof.

User systems 102A-102M are computers or other processing systems each including one or more processors, that are capable of communicating with any one or more of publisher servers 104A-104N. For example, each of user systems 102A-102M may include a client that enables a user who owns (or otherwise has access to) the user system to access sites (e.g., Web sites) that are hosted by publisher servers 104A-104N. For instance, a client may be a Web crawler, a Web browser, a non-Web-enabled client, or any other suitable type of client. By way of example, each of user systems 102A-102M is shown in FIG. 1 to be communicatively coupled to publisher 1 server(s) 104A for the purpose of accessing a site published by publisher 1. Persons skilled in the relevant art(s) will recognize that each of user systems 102A-102M is capable of connecting to any of publisher servers 104A-104N for accessing the sites hosted thereon.

Publisher servers 104A-104N are computers or other processing systems, each including one or more processors, that are capable of communicating with user systems 102A-102M. Each of publisher servers 104A-104N is configured to host a site (e.g., a Web site) published by a corresponding publisher 1-N so that such site is accessible to users of deal system 100 via user systems 102A-102M. Each of publisher servers 104A-104N is further configured to provide instances of one or more discounted offers (e.g., coupons, gift certificates, etc.) for a good and/or service to users of deal system 100 when those users access a Web site that is hosted by the respective publisher server.

Publisher servers 104A-104N are further configured to execute software programs that provide information to users in response to receiving requests, such as hypertext transfer protocol (HTTP) requests, from users, instant messaging (IM) applications, or web-based email. For example, the information may include Web pages, images, other types of files, output of executables residing on the publisher servers, IM chat sessions, emails, coupons, gift certificates, advertisements, etc. In accordance with this example, the software programs that are executing on publisher servers 104A-104N may provide Web pages and/or emails that include interface elements (e.g., buttons, widgets, hyperlinks, etc.) that a user may select for accessing the other types of information. The Web pages may be provided as hypertext markup language (HTML) documents and objects (e.g., files) that are linked therein, for example.

One type of software program that may be executed by any one or more of publisher servers 104A-104N is a different deal discount engine. For instance, publisher 1 server(s) 104A is shown to include different deal discount engine 108, which is configured to provide a variable or fixed discount for one or more offers presented via a Web site hosted by publisher server 104A. As previously mentioned, in example embodiments, instances of an offer may specify a variable discount. The amount of the discount may vary per customer (or group of customers) and/or per predetermined time interval. Once the deal is activated (i.e., a specified number of customers accept the deal), instances of the offer may specify a fixed discount.

Merchant system 106 is a computer or other processing system, including one or more processors, that is capable of providing discounted offers (e.g., coupons, gift certificates, etc.) for goods and/or services via a Web site hosted by a respective publisher server. By way of example, merchant system 106 is shown in FIG. 1 to be communicatively coupled to publisher 1 server(s) 104A for the purpose of serving offers to publisher 1. However, persons skilled in the relevant art(s) will recognize that merchant system 106 is capable of connecting to any of publisher servers 104A-104N for serving offers thereto. In addition, although one merchant system 106 is depicted in FIG. 1, persons skilled in the relevant art(s) will recognize that any number of merchant systems may be communicatively coupled to publisher 1 server(s) 104A.

Although merchant system 106 and user systems 102A-102M are depicted as desktop computers in FIG. 1, persons skilled in the relevant art(s) will appreciate that merchant system 106 and user systems 102A-102M may include any browser-enabled system or device, including but not limited to a laptop computer, a tablet computer, a personal digital assistant, a cellular telephone, or the like.

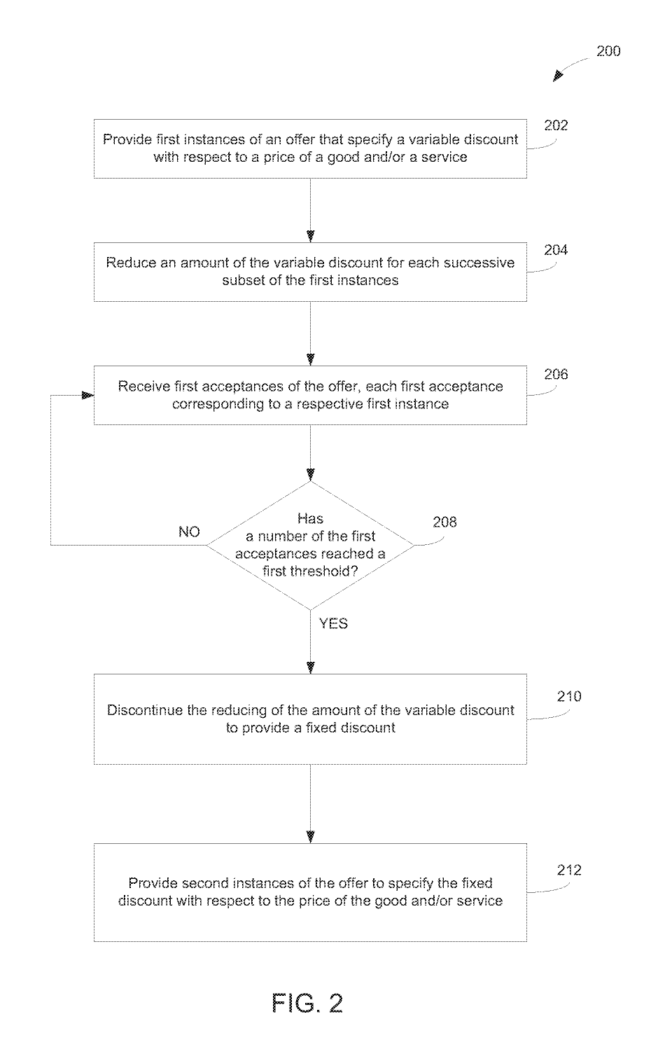

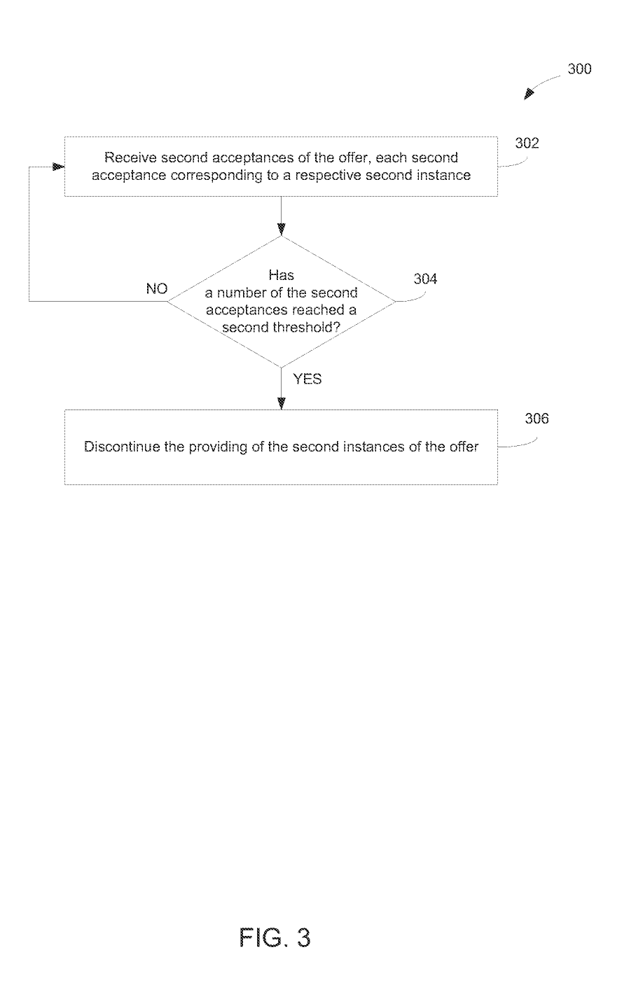

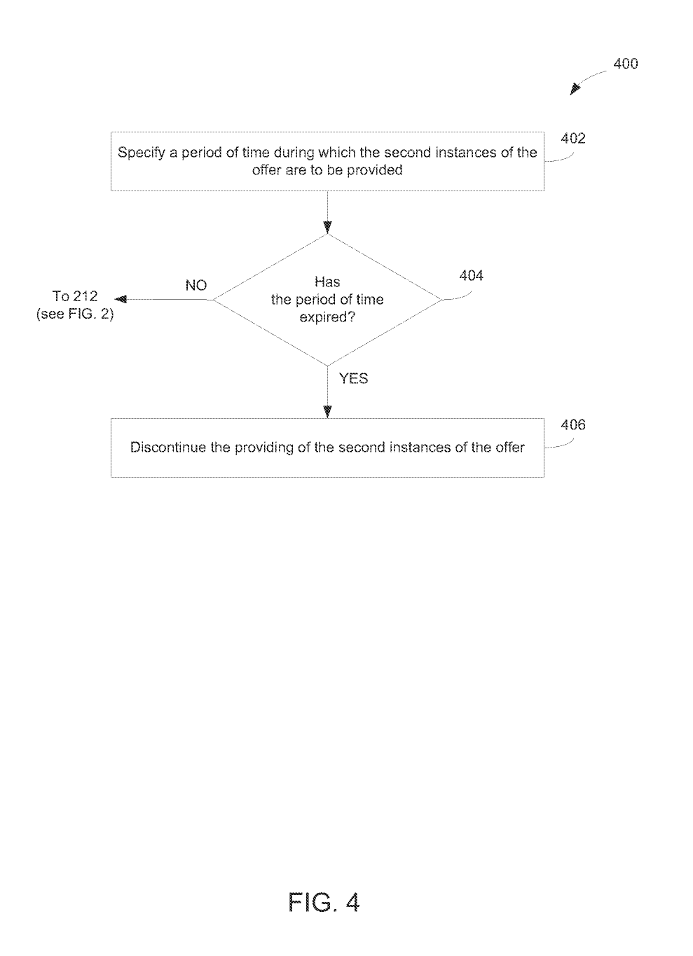

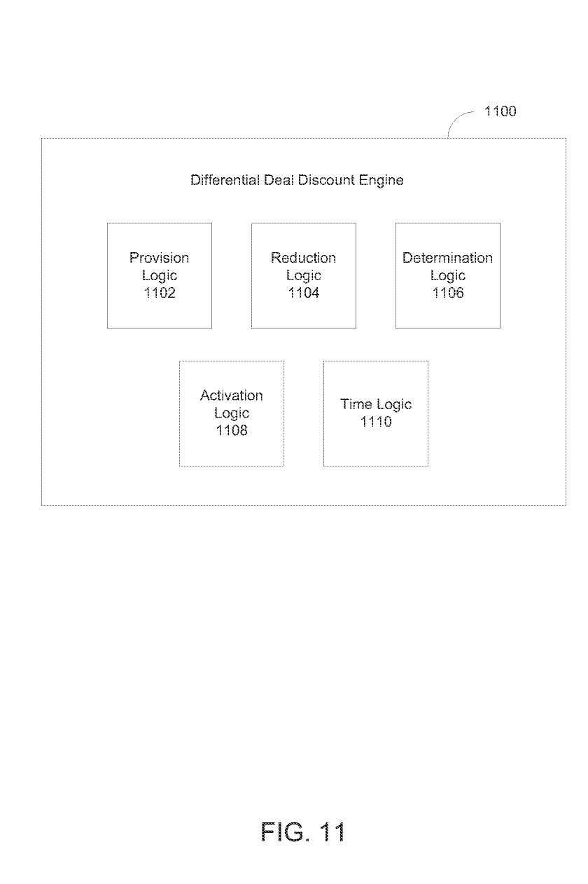

FIG. 2 depicts a flowchart 200 of an example method for providing instances of an offer specifying a variable discount in accordance with an embodiment described herein. FIGS. 3 and 4 depict flowcharts 300 and 400 of example methods for discontinuing provision of instances of an offer having a fixed discount in accordance with the embodiment described with respect to FIG. 2. Flowcharts 200, 300, and 400 may be performed by differential deal discount engine 108 of deal system 100 shown in FIG. 1, for example. For illustrative purposes, flowcharts 200, 300, and 400 are described with respect to differential deal discount engine 1100 shown in FIG. 11, which is an example of a differential deal discount engine 108, according to an embodiment. As shown in FIG. 11, differential deal discount engine 1100 includes provision logic 1102, reduction logic 1104, determination logic 1106, activation logic 1108, and time logic 1110. Further structural and operational embodiments will be apparent to persons skilled in the relevant art(s) based on the discussion regarding flowcharts 200, 300, and 400.

As shown in FIG. 2, the method of flowchart 200 begins at step 202. In step 202, first instances of an offer are provided. For example, the first instances may be provided via a Web site hosted by a publisher server (for example, publisher 1 server(s) 104A shown in FIG. 1). In another example, the first instances may be provided via email, short message service (SMS), instant message (IM), or any other suitable messaging technology. The first instances specify a variable discount with respect to a price of a good and/or a service. Each of the first instances may be represented as a coupon, a gift certificate, etc. In an example implementation, provision logic 1102 provides the first instances of the offer.

At step 204, an amount of the variable discount for each successive subset of the first instances is reduced. Each subset of the first instances may correspond to a predetermined number of acceptances received for the offer. For example, a first subset of the first instances may correspond to five acceptances, while a second subset of the first instances may correspond to ten acceptances. In accordance with this example, the first five customers who accept the offer will receive a greater discount than the next ten customers who accept the offer. It is noted that the number of subsets of the first instances, the number of acceptances corresponding to each of the subsets, and the amount of the discount for each of the subsets described with reference to step 204 are provided for illustrative purposes and are not intended to be limiting. As such, the first instances may be divided into any suitable number of subsets; any suitable number of acceptances may correspond to each subset; and the amount of the discount for each of the subsets may be any suitable value. In an example implementation, reduction logic 1104 reduces the amount of the variable discount for each successive subset of the first instances.

In an example embodiment, the number of subsets of the first instances, the number of acceptances corresponding to each subset, and/or the amount of the discount for each subset may be exposed as a configurable parameter to a system administrator (e.g., a merchant providing the offer via merchant system 106), thereby allowing these values to be selected to achieve desired performance.

At step 206, first acceptances of the offer are received. Each first acceptance corresponds to a respective first instance. In an example implementation, determination logic 1106 receives the first acceptances of the offer.

At step 208, a determination is made whether a number of the first acceptances reaches (e.g., is greater than or equal to) a first threshold. In one embodiment, the first threshold is a maximum number of acceptances allowed for the offer specifying the variable discount. In an example implementation, determination logic 1106 determines whether the number of the first acceptances reaches the first threshold. If the number of the first acceptances reaches the first threshold, flow continues to step 210. Otherwise, flow returns to step 206.

In an example embodiment, the first threshold may be exposed as a configurable parameter to a system administrator (e.g., a merchant providing the offer via merchant system 106), thereby allowing the first threshold to be selected to achieve desired performance.

In another example embodiment, the discount offered for a specified good and/or service may be claimed only if the number of the first acceptances reaches the first threshold. In accordance with this embodiment, once an offer receives the required number of acceptances, the deal corresponding to the offer is activated, and each customer that accepted the offer (e.g., purchased the deal) receives the discount. However, if not enough customers accept the offer, then the deal is not activated (i.e., the deal is canceled), in which case none of the customers who accepted the offer receive the deal. In an example implementation, activation logic 1108 activates the deal if the number of the first acceptances reaches the first threshold.

In yet another example embodiment, a determination is made whether the number of the first acceptances is less than the first threshold for a designated period of time. If such a determination is made, the providing of the first instances is discontinued. In an example implementation, determination logic 1106 determines whether the number of the first acceptances is less than the first threshold for the designated period of time. In accordance with this implementation, provision logic 1102 discontinues the providing of the first instances. In some example embodiments, the designated period of time may be exposed as a configurable parameter to a system administrator (e.g., a merchant providing the offer via merchant system 106), thereby allowing the designated period of time to be selected to achieve desired performance.

In still another example embodiment, in response to determining that the number of the first acceptances is less than the first threshold for the designated period of time, the deal corresponding to the offer is not activated. For instance, the offer may be invalidated for each customer that has accepted the offer.

At step 210, the reducing of the amount of the variable discount is discontinued to provide a fixed discount. In an example implementation, reduction logic 1104 discontinues the reducing of the amount of the variable discount.

At step 212, second instances of the offer are provided. For example, the second instances may be provided via a Web site, a messaging technology, etc. The second instances specify the fixed discount with respect to the price of the good and/or service. In an example implementation, provision logic 1102 provides the second instances of the offer.

In an example embodiment, the amount of the fixed discount is exposed as a configurable parameter to a system administrator (e.g., a merchant providing the offer via merchant system 106), thereby allowing the fixed discount to be selected to achieve desired performance.

In some example embodiments, one or more steps 202, 204, 206, 208, 210, and/or 212 of flowchart 200 may not be performed. Moreover, steps in addition to or in lieu of steps 202, 204, 206, 208, 210, and/or 212 may be performed.

One example method for discontinuing the providing of the second instances of the offer will now be described with reference to flowchart 300 of FIG. 3. As shown in FIG. 3, the method of flowchart 300 begins at step 302. In step 302, second acceptances of the offer are received. Each second acceptance corresponds to a respective second instance of the offer. In an example implementation, determination logic 1106 receives the second acceptances of the offer.

At step 304, a determination is made whether a number of the second acceptances reaches (e.g., is greater than or equal to) a second threshold. For instance, the second threshold may be a maximum number of acceptances allowed for the offer specifying the fixed discount. In an example implementation, determination logic 1106 determines whether the number of the second acceptances reached the second threshold. If the number of the second acceptances reaches the second threshold, flow continues to step 306. Otherwise, flow returns to step 302.

In an example embodiment, the second threshold is exposed as a configurable parameter to a system administrator (e.g., a merchant providing the offer via merchant system 106), thereby allowing the second threshold to be selected to achieve desired performance.

At step 306, the providing of the second instances of the offer is discontinued. In an example implementation, provision logic 1102 discontinues the providing of the second instances of the offer.

In some example embodiments, one or more steps 302, 304, and/or 306 of flowchart 300 may not be performed. Moreover, steps in addition to or in lieu of steps 302, 304, and/or 306 may be performed.

Another example method for discontinuing the providing of the second instances of the offer will now be described with reference to flowchart 400 of FIG. 4. As shown in FIG. 4, the method of flowchart 400 begins at step 402. In step 402, a period of time during which the second instances of the offer are to be provided is specified. In an example implementation, timer logic 1110 specifies the period of time during which the second instances of the offer are to be provided.

At step 404, a determination is made whether the period of time has expired. In an example implementation, determination logic 1106 determines whether the period of time has expired. If the period of time has expired, flow continues to step 406. Otherwise, flow continues to step 212 of FIG. 2.

In an example embodiment, the period of time is exposed as a configurable parameter to a system administrator (e.g., a merchant providing the offer via merchant system 106), thereby allowing the period of time to be selected to achieve desired performance.

At step 406, the providing of the second instances of the offer is discontinued. In an example implementation, provision logic 1102 discontinues the providing of the second instances of the offer.

In some example embodiments, one or more steps 402, 404, and/or 406 of flowchart 400 may not be performed. Moreover, steps in addition to or in lieu of steps 402, 404, and/or 406 may be performed.

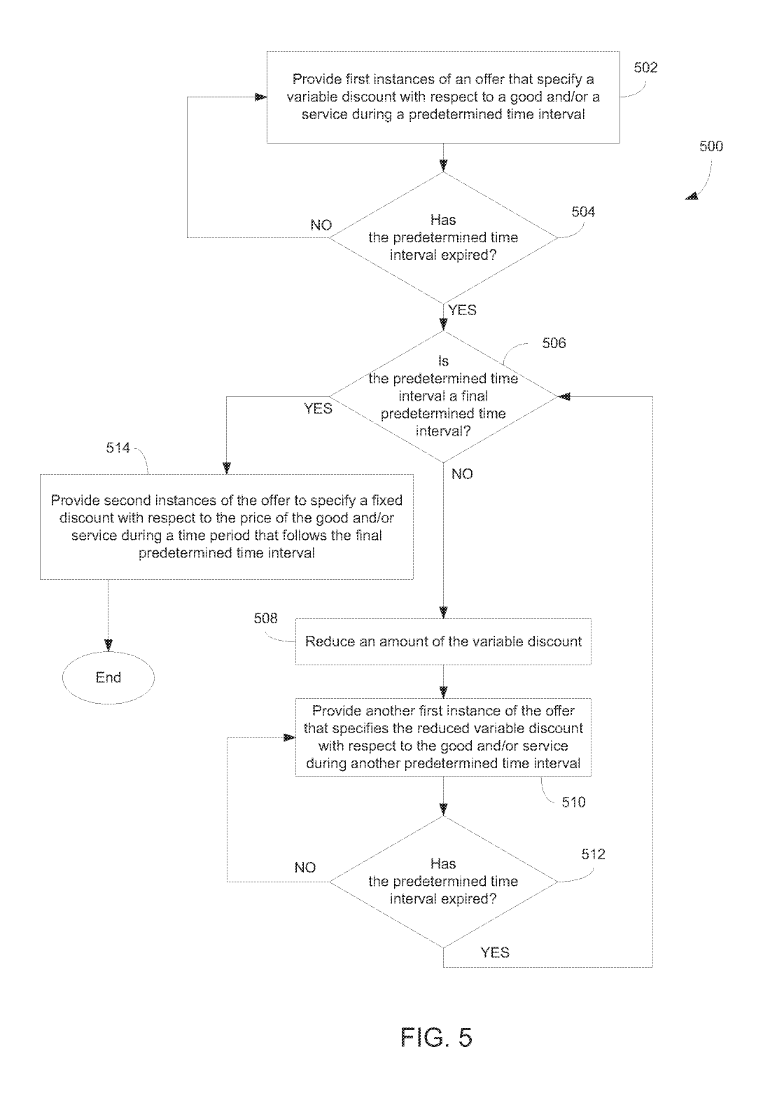

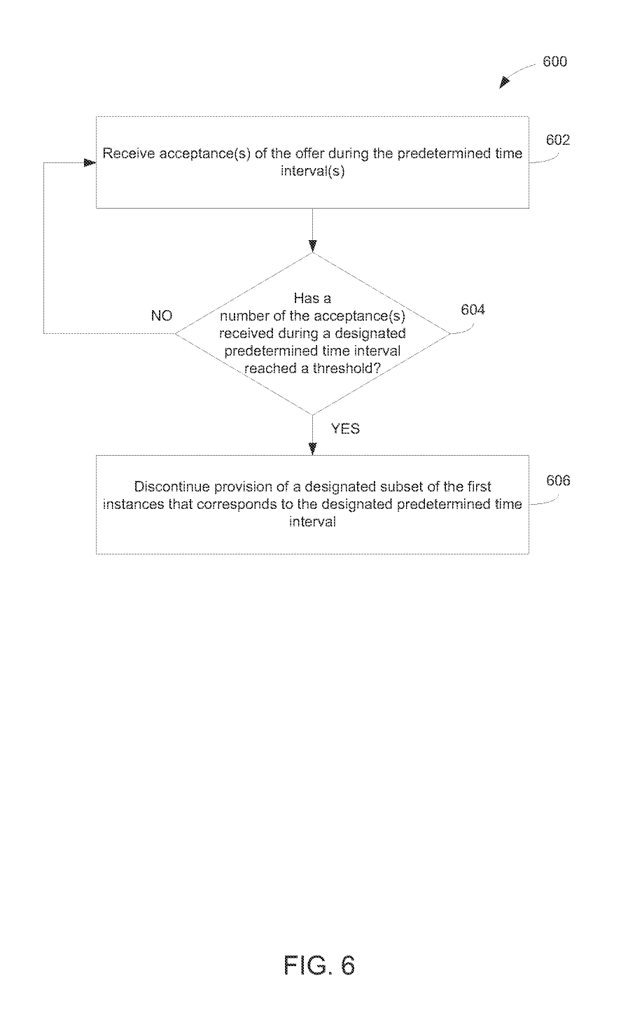

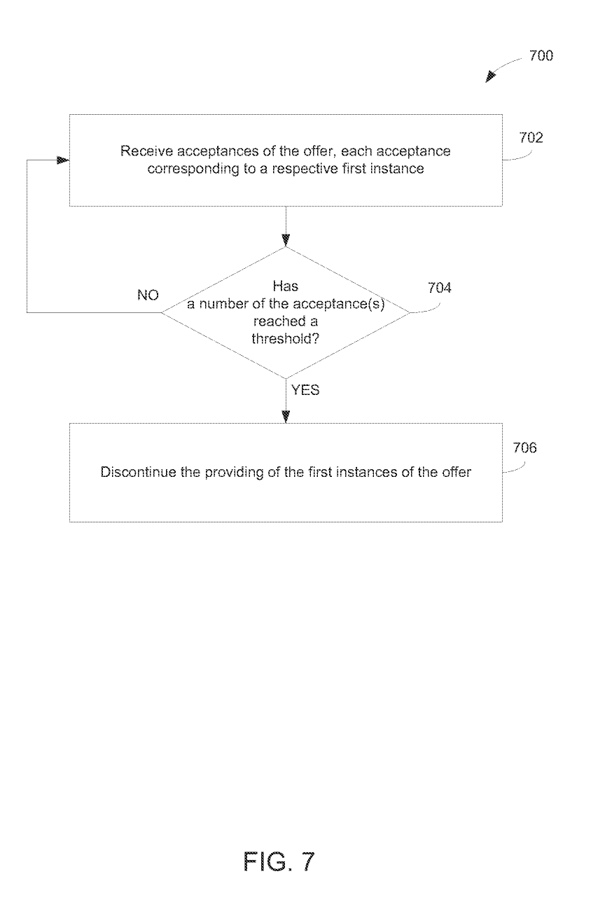

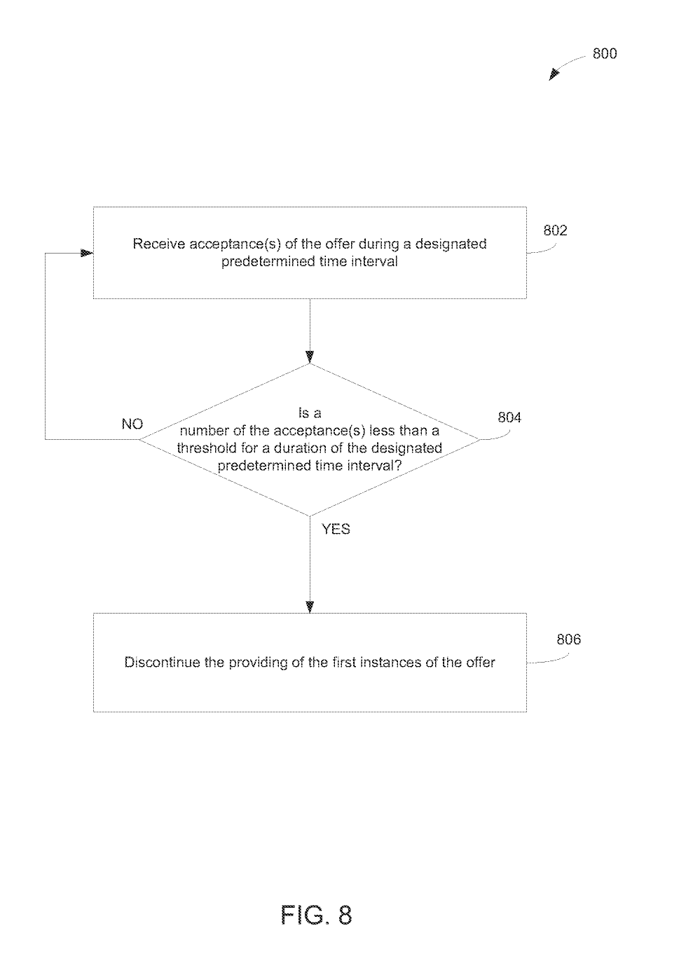

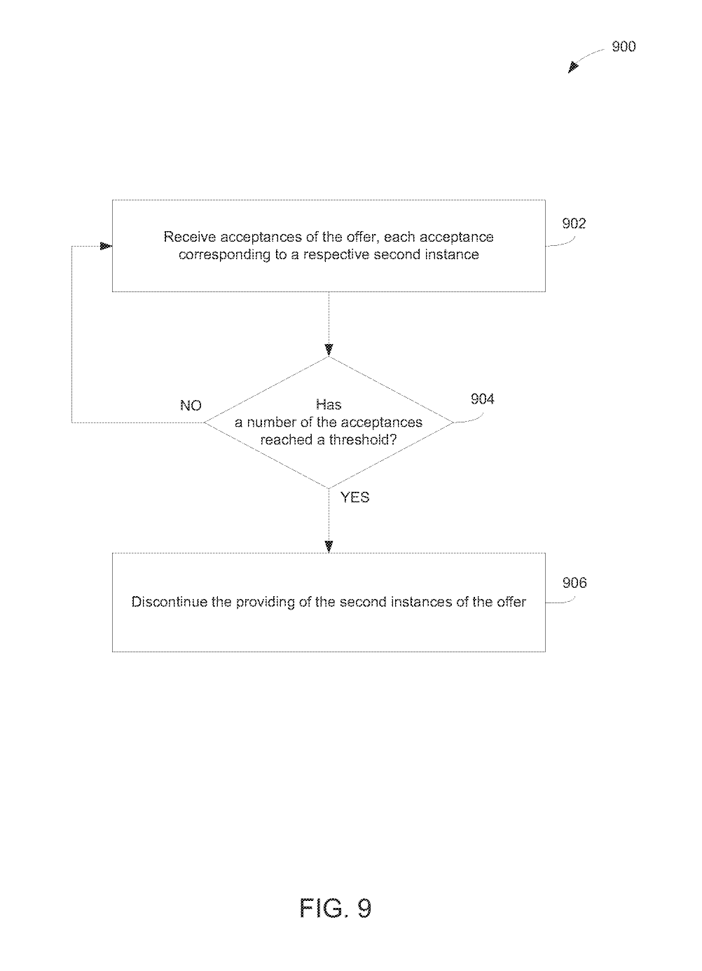

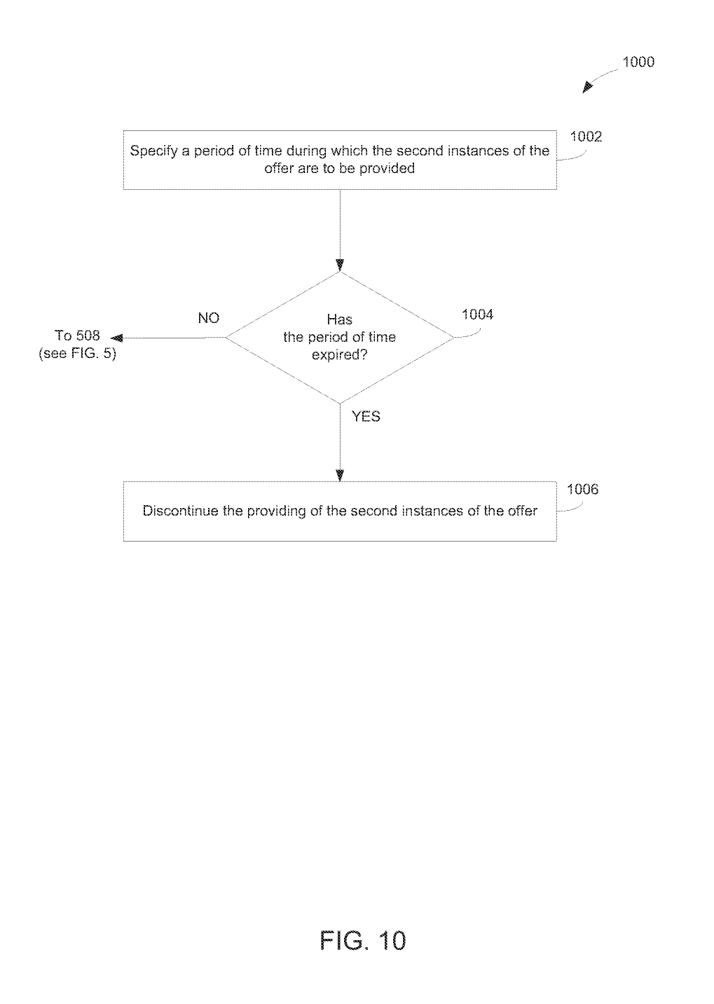

FIG. 5 depicts a flowchart 500 of another example method for providing instances of an offer specifying a variable discount in accordance with embodiments described herein. FIG. 6 depicts a flowchart 600 of an example method for discontinuing provision of instances of an offer specifying a variable discount during a designated predetermined time interval in accordance with the embodiment described with respect to FIG. 5. FIGS. 7 and 8 depict flowcharts 700 and 800 of example methods for discontinuing provision of instances of an offer specifying a variable discount in accordance with the embodiment described with respect to FIG. 5. FIGS. 9 and 10 depict flowcharts 900 and 1000 of example methods for discontinuing provision of instances of an offer specifying a fixed discount in accordance with the embodiment described with respect to FIG. 5. Flowcharts 500, 600, 700, 800, 900, and 1000 may be performed by differential deal discount engine 108 of deal system 100 shown in FIG. 1, for example. For illustrative purposes, flowcharts 500, 600, 700, 800, 900, and 1000 are described with respect to differential deal discount engine 1100 shown in FIG. 11, which is an example of a differential deal discount engine 108, according to an embodiment.

In one embodiment, the amount of the discount may vary for a given predetermined time interval. In accordance with this embodiment, customer(s) who accept a deal during a predetermined time interval that occurs earlier than another predetermined time interval in which the deal is offered may be given a greater discount. Accordingly, as the time in which the deal is offered increases, the amount of the discount may decrease.

An example method for providing instances of an offer specifying a variable discount for a predetermined time interval will now be described with reference to flowchart 500 of FIG. 5. As shown in FIG. 5, the method of flowchart 500 begins at step 502. In step 502, first instances of an offer are provided during a predetermined time interval. For example, the first instances may be provided via a Web site, a messaging technology, etc. The first instances specify a variable discount with respect to a price of a good and/or a service. Each of the first instances may be represented as a coupon, a gift certificate, etc. In an example implementation, provision logic 1102 provides the first instances of the offer.

At step 504, a determination is made whether the predetermined time interval has expired. In an example implementation, determination logic 1106 determines whether the predetermined period of time has expired. If the period of time has expired, flow continues to step 506. Otherwise, flow returns to step 502.

In an example embodiment, the predetermined time interval is exposed as a configurable parameter to a system administrator (e.g., a merchant providing the offer via merchant system 106), thereby allowing the predetermined time interval to be selected to achieve desired performance.

At step 506, a determination is made whether the predetermined time interval is a final predetermined time interval. In an example implementation, determination logic 1106 determines whether the predetermined time interval is the final predetermined time interval. The final predetermined time interval is the last predetermined time interval during which a first instance of the offer is to be provided. If the predetermined time interval is the final predetermined time interval, flow continues to step 514. Otherwise, flow continues to step 508.

In an example embodiment, the designation of which predetermined time interval is the final predetermined time interval may be exposed as a configurable parameter to a system administrator (e.g., a merchant providing the offer via merchant system 106), thereby allowing the final predetermined time interval to be selected to achieve desired performance.

In another example embodiment, in response to the expiration of the final predetermined time interval, a deal corresponding to the offer is activated, meaning that each customer who accepted the offer (e.g., purchased the deal) receives the discount. However, if not enough customers accept the offer during the predetermined time interval (i.e., the number of customers that accepted are less than a threshold), then the deal is not activated (e.g., the deal is canceled), in which case none of the customers who accepted the offer receive the deal. In an example implementation, activation logic 1108 activates the deal that corresponds to the offer upon expiration of the final predetermined time interval.

At step 508, an amount of the variable discount is reduced. In an example implementation, reduction logic 1104 reduces the amount of the variable discount.

At step 510, another first instance of the offer that specifies the reduced variable discount with respect to the good and/or service is provided. In an example implementation, provision logic 1102 provides another first instance of the offer (e.g., via a Web site or a messaging technology).

In an example embodiment, the amount of the variable discount for each predetermined time interval may be exposed as a configurable parameter to a system administrator (e.g., a merchant providing the offer via merchant system 106), thereby allowing each amount to be selected to achieve desired performance.

At step 512, a determination is made whether the predetermined time interval in which the other first instance is provided has expired. In an example implementation, determination logic 11106 determines whether the predetermined time interval has expired. If the predetermined time interval has expired, flow returns to step 506. Otherwise, flow returns to step 510.

In an example embodiment, the predetermined time interval may be exposed as a configurable parameter to a system administrator (e.g., a merchant providing the offer via merchant system 106), thereby allowing the predetermined time interval to be selected to achieve desired performance.

At step 514, in response to determining that the predetermined time interval is the final predetermined time interval (at step 506), second instances of the offer are provided during a time period that follows the final predetermined time interval. The second instances specify a fixed discount with respect to the price of the good and/or service. In an example implementation, provision logic 1102 provides the second instances of the offer (e.g., via a Web site or a messaging technology).

In an example embodiment, the amount of the fixed discount is exposed as a configurable parameter to a system administrator (e.g., a merchant providing the offer via merchant system 106), thereby allowing the fixed discount to be selected to achieve desired performance.

In some example embodiments, one or more steps 502, 504, 506, 508, 510, 512, and/or 514 of flowchart 500 may not be performed. Moreover, steps in addition to or in lieu of steps 502, 504, 506, 508, 510, 512, and/or 514 may be performed.

In one example embodiment, the first instances of the offer provided during a predetermined time interval may be discontinued when a number of acceptance(s) received during the predetermined time interval reaches a threshold. This may occur if the number of acceptance(s) received during the predetermined time interval reaches the threshold before the predetermined time interval expires. For instance, the providing of the first instances of the offer may be discontinued upon the earlier of the predetermined time interval expiring or the number of acceptance(s) received during the predetermined time interval reaching the threshold.

An example method for discontinuing the providing of instances of an offer specifying a variable discount during a designated predetermined time interval will now be described with reference to flowchart 600 of FIG. 6. As shown in FIG. 6, the method of flowchart 600 begins at step 602. At step 602, acceptance(s) of the offer are received during one or more predetermined time intervals. In an example implementation, determination logic 1106 receives the one or more acceptances of the offer.

At step 604, a determination is made whether a number of the acceptance(s) received during a designated predetermined time interval reached a threshold. For example, the threshold may be a maximum number of acceptances allowed for the offer specifying the variable discount during the designated predetermined time interval. In an example implementation, determination logic 1106 determines whether the number of the acceptance(s) received during the designated predetermined time interval reaches the threshold. If the number of the acceptance(s) received during the designated predetermined time interval reaches the threshold, flow continues to step 606. Otherwise, flow returns to step 602.

In an example embodiment, the threshold is exposed as a configurable parameter to a system administrator (e.g., a merchant providing the offer via merchant system 106), thereby allowing the threshold to be selected to achieve desired performance.

At step 606, the providing of a designated subset of the first instances that corresponds to the designated predetermined time interval is discontinued. In an example implementation, provision logic 1102 discontinues the providing of the designated subset of the first instances.

In some example embodiments, one or more steps 602, 604, and/or 606 of flowchart 606 may not be performed. Moreover, steps in addition to or in lieu of steps 602, 604, and/or 606 may be performed.

In an example embodiment, all first instances of an offer may be discontinued when a total number of acceptance(s) of the offer that are received reaches a threshold. This may occur regardless of reaching the final predetermined time interval, which, as previously mentioned, may also cause provision of the first instances of the offer to be discontinued upon its expiration.

An example method for discontinuing the providing of instances of an offer specifying a variable discount will now be described with reference to flowchart 700 of FIG. 7. As shown in FIG. 7, the method of flowchart 700 begins at step 702. At step 702, acceptance(s) of the offer are received. Each acceptance corresponds to a respective first instance of the offer. In an example implementation, determination logic 1106 receives the acceptance(s) of the offer.

At step 704, a determination is made whether a number of the acceptance(s) reaches (e.g., is greater than or equal to) the threshold. For instance, the threshold may be a maximum number of acceptances allowed for all first instances of the offer specifying the variable discount. In an example implementation, determination logic 1106 determines whether the number of the acceptance(s) reached the threshold. If the number of the acceptance(s) reaches the threshold, flow continues to step 706. Otherwise, flow returns to step 702.

At step 706, the providing of the first instances of the offer is discontinued. In an example implementation, provision logic 1102 discontinues the providing of the first instances of the offer.

In an example embodiment, the threshold is exposed as a configurable parameter to a system administrator (e.g., a merchant providing the offer via merchant system 106), thereby allowing the threshold to be selected to achieve desired performance.

In some example embodiments, one or more steps 702, 704, and/or 706 of flowchart 700 may not be performed. Moreover, steps in addition to or in lieu of steps 702, 704, and/or 706 may be performed.

Another example method for discontinuing the providing of instances of an offer specifying a variable discount will now be described with reference to flowchart 800 of FIG. 8. As shown in FIG. 8, the method of flowchart 800 begins at step 802. At step 802, acceptance(s) of the offer are received during a designated predetermined time interval. In an example implementation, determination logic 1106 receives the acceptance(s) of the offer.

At step 804, a determination is made whether a number of the acceptance(s) is less than a threshold for a duration of the designated predetermined time interval. For example, the threshold may be a minimum number of acceptances needed in order to advance to the next predetermined time interval. In an example implementation, determination logic 1106 determines whether the number of the acceptance(s) of the offer is less than the threshold for the duration of the designated predetermined time interval. If the number of the acceptance(s) of the offer is less than the threshold for the duration of the designated predetermined time interval, flow continues to step 806. Otherwise, flow returns to step 802.

At step 806, the providing of the first instances of the offer is discontinued. In an example implementation, provision logic 1102 discontinues the providing of the first instances of the offer.

In an example embodiment, the threshold may be exposed as a configurable parameter to a system administrator (e.g., a merchant providing the offer via merchant system 106), thereby allowing the threshold to be selected to achieve desired performance.

In some example embodiments, one or more steps 802, 804, and/or 806 of flowchart 800 may not be performed. Moreover, steps in addition to or in lieu of steps 802, 804, and/or 806 may be performed.

An example method for discontinuing the providing of instances of an offer specifying a fixed discount will now be described with reference to flowchart 900 of FIG. 9. As shown in FIG. 9, the method of flowchart 900 begins at step 902. At step 902, acceptances of the offer are received. Each acceptance corresponds to a respective second instance of the offer. As previously mentioned, an instance of the offer specifying the fixed discount is provided for each second instance. In an example implementation, determination logic 1106 receives the acceptances of the offer.

At step 904, a determination is made whether a number of the acceptances reaches (e.g., is greater than or equal to) a threshold. For example, the threshold may be a maximum number of acceptances allowed for the offer specifying the fixed discount. In an example implementation, determination logic 1106 determines whether the number of the acceptances reached the threshold. If the number of the acceptances of the offer reaches the threshold, flow continues to step 906. Otherwise, flow returns to step 902.

In some example embodiments, the threshold may be exposed as a configurable parameter to a system administrator (e.g., a merchant providing the offer via merchant system 106), thereby allowing the threshold to be selected to achieve desired performance.

At step 906, the providing of the second instances of the offer is discontinued. In an example implementation, provision logic 1102 discontinues the providing of the second instances of the offer.

In some example embodiments, one or more steps 902, 904, and/or 906 of flowchart 900 may not be performed. Moreover, steps in addition to or in lieu of steps 902, 904, and/or 906 may be performed.

Another example method for discontinuing the providing of instances of an offer specifying a fixed discount will now be described with reference to flowchart 1000 of FIG. 10. As shown in FIG. 10, the method of flowchart 1000 begins at step 1002. In step 1002, a period of time during which the second instances of the offer are to be provided is specified. As previously mentioned, an instance of the offer specifying the fixed discount is provided for each second instance. In an example implementation, timer logic 1110 specifies the period of time during which the second instances of the offer are to be provided.

At step 1004, a determination is made whether the period of time has expired. In an example implementation, determination logic 1106 determines whether the period of time has expired. If the period of time has expired, flow continues to step 1006. Otherwise, flow returns to step 1002.

In an example embodiment, the period of time may be exposed as a configurable parameter to a system administrator (e.g., a merchant providing the offer via merchant system 106), thereby allowing the period of time to be selected to achieve desired performance.

At step 1006, the providing of the second instances of the offer is discontinued. In an example implementation, provision logic 1102 discontinues the providing of the second instances of the offer.

In some example embodiments, one or more steps 1002, 1004, and/or 1006 of flowchart 1000 may not be performed. Moreover, steps in addition to or in lieu of steps 1002, 1004, and/or 1006 may be performed.

It will be recognized that differential deal discount engine 1100 may not include one or more of provision logic 1102, reduction logic 1104, determination logic 1106, activation logic 1108, and/or time logic 1110. Furthermore, differential deal discount engine 1100 may include logic in addition to or in lieu of provision logic 1102, reduction logic 1104, determination logic 1106, activation logic 1108, and/or time logic 1110.

### III. Other Example Embodiments

Differential deal discount engine 108, differential deal discount engine 1100, provision logic 1102, reduction logic 1104, determination logic 1106, activation logic 1108, and time logic 1110 may be implemented in hardware, software, firmware, or any combination thereof. For example, differential deal discount engine 108, differential deal discount engine 1100, provision logic 1102, reduction logic 1104, determination logic 1106, activation logic 1108, and/or time logic 1110 may be implemented as computer program code configured to be executed in one or more processors. In another example, differential deal discount engine 108, differential deal discount engine 1100, provision logic 1102, reduction logic 1104, determination logic 1106, activation logic 1108, and/or time logic 1110 may be implemented as hardware logic/electrical circuitry.

### IV. Example Computer Implementation

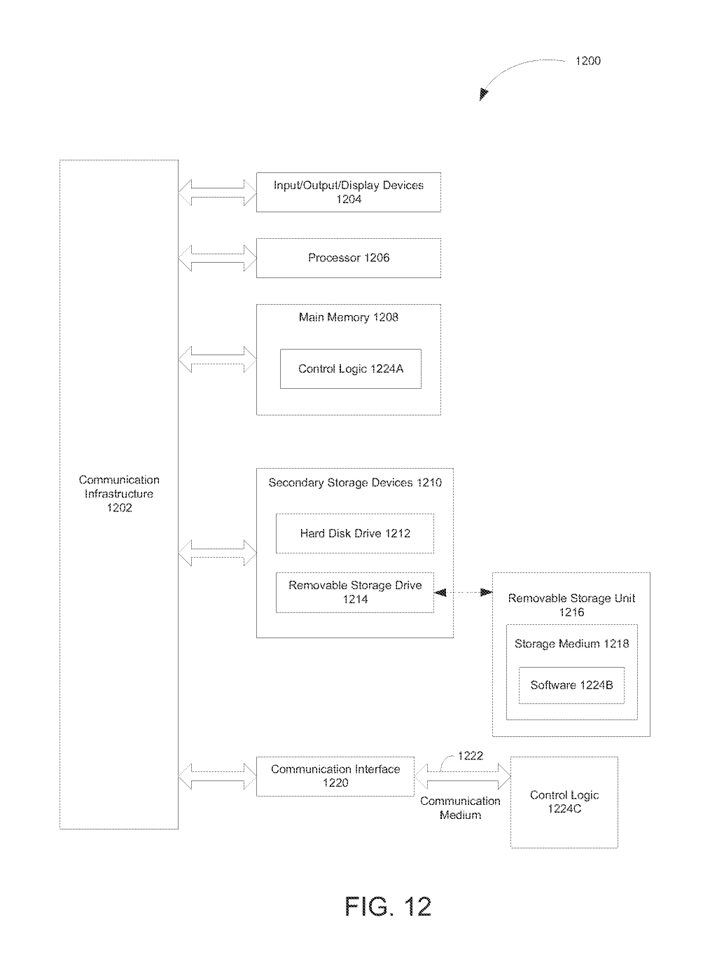

The embodiments described herein, including systems, methods/processes, and/or apparatuses, may be implemented using well known servers/computers, such as computer 1200 shown in FIG. 12. For instance, elements of example deal system 100, including any of the user systems 102A-102M, any of the publisher servers 104A-104N, and/or merchant system 106 depicted in FIG. 1 and elements thereof, each of the steps of flowchart 200 depicted in FIG. 2, each of the steps of flowchart 300 depicted in FIG. 3, each of the steps of flowchart 400 depicted in FIG. 4, each of the steps of flowchart 500 depicted in FIG. 5, each of the steps of flowchart 600 depicted in FIG. 6, each of the steps of flowchart 700 depicted in FIG. 7, each of the steps of flowchart 800 depicted in FIG. 8, each of the steps of flowchart 900 depicted in FIG. 9, and each of the steps of flowchart 1000 depicted in FIG. 10 can each be implemented using one or more computers 1200.

Computer 1200 can be any commercially available and well known computer capable of performing the functions described herein, such as computers available from International Business Machines, Apple, Sun, HP, Dell, Cray, etc. Computer 1200 may be any type of computer, including a desktop computer, a server, etc.

As shown in FIG. 12, computer 1200 includes one or more processors (e.g., central processing units (CPUs)), such as processor 1206. Processor 1206 may include differential deal discount engine 108 of FIG. 1; provision logic 1102, reduction logic 1104, determination logic 1106, activation logic 1108, and/or time logic 1110 of FIG. 11; or any portion or combination thereof, for example, though the scope of the embodiments is not limited in this respect. Processor 1206 is connected to a communication infrastructure 1202, such as a communication bus. In some embodiments, processor 1206 can simultaneously operate multiple computing threads.

Computer 1200 also includes a primary or main memory 1208, such as a random access memory (RAM). Main memory has stored therein control logic 1224A (computer software), and data.

Computer 1200 also includes one or more secondary storage devices 1210. Secondary storage devices 1210 include, for example, a hard disk drive 1212 and/or a removable storage device or drive 1214, as well as other types of storage devices, such as memory cards and memory sticks. For instance, computer 1200 may include an industry standard interface, such as a universal serial bus (USB) interface for interfacing with devices such as a memory stick. Removable storage drive 1214 represents a floppy disk drive, a magnetic tape drive, a compact disk drive, an optical storage device, tape backup, etc.

Removable storage drive 1214 interacts with a removable storage unit 1216. Removable storage unit 1216 includes a computer useable or readable storage medium 1218 having stored therein computer software 1224B (control logic) and/or data. Removable storage unit 1216 represents a floppy disk, magnetic tape, compact disc (CD), digital versatile disc (DVD), Blue-ray disc, optical storage disk, memory stick, memory card, or any other computer data storage device. Removable storage drive 1214 reads from and/or writes to removable storage unit 1216 in a well-known manner.

Computer 1200 also includes input/output/display devices 1204, such as monitors, keyboards, pointing devices, etc.

Computer 1200 further includes a communication or network interface 1220. Communication interface 1220 enables computer 1200 to communicate with remote devices. For example, communication interface 1220 allows computer 1200 to communicate over communication networks or mediums 1222 (representing a form of a computer useable or readable medium), such as local area networks (LANs), wide area networks (WANs), the Internet, etc. Network interface 1220 may interface with remote sites or networks via wired or wireless connections. Examples of communication interface 1222 include but are not limited to a modem, a network interface card (e.g., an Ethernet card), a communication port, a Personal Computer Memory Card International Association (PCMCIA) card, etc.

Control logic 1224C may be transmitted to and from computer 1200 via the communication medium 1222.

Any apparatus or manufacture comprising a computer useable or readable medium having control logic (software) stored therein is referred to herein as a computer program product or program storage device. This includes, but is not limited to, computer 1200, main memory 1208, secondary storage devices 1210, and removable storage unit 1216. Such computer program products, having control logic stored therein that, when executed by one or more data processing devices, cause such data processing devices to operate as described herein, represent embodiments of the invention.

For example, each of the elements of differential deal discount engine 108 depicted in FIG. 1; provision logic 1102, reduction logic 1104, determination logic 1106, activation logic 1108, and/or time logic 1110, each depicted in FIG. 11; each of the steps of flowchart 200 depicted in FIG. 2; each of the steps of flowchart 300 depicted in FIG. 3; each of the steps of flowchart 400 depicted in FIG. 4; each of the steps of flowchart 500 depicted in FIG. 5; each of the steps of flowchart 600 depicted in FIG. 6; each of the steps of flowchart 700 depicted in FIG. 7; each of the steps of flowchart 800 depicted in FIG. 8; each of the steps of flowchart 9 depicted in FIG. 9; and each of the steps of flowchart 1000 depicted in FIG. 10 can be implemented as control logic that may be stored on a computer useable medium or computer readable medium, which can be executed by one or more processors to operate as described herein.

Computer readable storage media are distinguished from and non-overlapping with communication media. Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Example embodiments are also directed to such communication media.

### V. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

The proper interpretation of subject matter described and claimed herein is limited to patentable subject matter under 35 U.S.C. §101. As described and claimed herein, a method is a process defined by 35 U.S.C. §101. As described and claimed herein, each of a device, apparatus, machine, system, computer, module, computer readable media, media, is a machine or manufacture defined by 35 U.S.C. §101.

What is claimed is:

1. A method, comprising:
providing a first plurality of instances of an offer that specifies a variable discount with respect to a price of at least one of a good or a service;
reducing an amount of the variable discount for each successive subset of the first plurality of instances, each subset including one or more instances of the first plurality of instances;
receiving a first plurality of acceptances of the offer, each of the first plurality of acceptances corresponding to a respective instance of the first plurality of instances;
determining, by a processor, whether a number of the first plurality of acceptances reaches a first threshold;
discontinuing the reducing of the amount of the variable discount to provide a fixed discount in response to determining that the number of the first plurality of acceptances reaches the first threshold; and
providing a second plurality of instances of the offer to specify the fixed discount with respect to the price of the at least one of the good or the service in response to discontinuing the reducing of the amount of the variable discount.

2. The method of claim 1, further comprising:
activating a deal that corresponds to the offer in response to determining that the number of the first plurality of acceptances reaches the first threshold.

3. The method of claim 1, further comprising:
receiving a second plurality of acceptances of the offer, each of the second plurality of acceptances corresponding to a respective instance of the second plurality of instances;
determining whether a number of the second plurality of acceptances reaches a second threshold; and
discontinuing the providing of the second plurality of instances of the offer in response to determining that the number of the second plurality of acceptances reaches the second threshold.

4. The method of claim 1, further comprising:
determining whether the number of the first plurality of acceptances is less than the first threshold for a designated period of time; and
discontinuing the providing of the first plurality of instances of the offer in response to determining that the number of the first plurality of acceptances is less than the first threshold for the designated period of time.

5. The method of claim 4, further comprising:
not activating a deal, which corresponds to the offer, for the first plurality of acceptances in response to determining that the number of the first plurality of acceptances is less than the first threshold for the designated period of time.

6. The method of claim 1, further comprising:
specifying a period of time during which the second plurality of instances of the offer is to be provided; and
discontinuing the providing of the second plurality of instances of the offer in response to expiration of the period of time.

7. A method, comprising:
providing a first plurality of instances of an offer that specifies a variable discount with respect to a price of at least one of a good or a service among a plurality of predetermined time intervals, each predetermined time interval of the plurality of predetermined time intervals corresponding to a respective subset of the first plurality of instances, each subset including one or more instances of the first plurality of instances;
reducing an amount of the variable discount upon expiration of each of the plurality of predetermined time intervals;
determining, by a processor, a final predetermined time interval of the plurality of predetermined time intervals; and
providing a second plurality of instances of the offer to specify a fixed discount with respect to the price of the at least one of the good or the service during a time period that follows the final predetermined time interval.

8. The method of claim 7, further comprising:
receiving a plurality of acceptances of the offer, each acceptance of the plurality of acceptances corresponding to a respective instance of the first plurality of instances;
determining whether a number of the plurality of acceptances reaches a threshold; and
discontinuing the providing of the first plurality of instances of the offer in response to determining that the number of the plurality of acceptances reaches the threshold.

9. The method of claim 7, further comprising:
receiving one or more acceptances of the offer during each of one or more predetermined time intervals of the plurality of predetermined time intervals; and
for each of the one or more predetermined time intervals, determining whether a number of the one or more acceptances received during that predetermined time interval reaches a threshold; and
discontinuing provision of a designated subset of the first plurality of instances that corresponds to a designated predetermined time interval of the one or more predetermined time intervals in response to determining that the number of the one or more acceptances received during the designated predetermined time interval reaches the threshold.

10. The method of claim 7, further comprising:
activating a deal that corresponds to the offer in response to expiration of the final predetermined time interval.

11. The method of claim 7, further comprising:
receiving a plurality of acceptances of the offer, each acceptance of the plurality of acceptances corresponding to a respective instance of the second plurality of instances;
determining whether a number of the plurality of acceptances reaches a threshold; and
discontinuing the providing of the second plurality of instances of the offer in response to determining that the number of the plurality of acceptances reaches the threshold.

12. The method of claim 7, further comprising:
receiving one or more acceptances of the offer during a designated predetermined time interval of the plurality of predetermined time intervals;
determining whether a number of the one or more acceptances is less than a threshold for a duration of the designated predetermined time interval; and
discontinuing the providing of the first plurality of instances of the offer in response to determining that the number of the one or more acceptances is less than the threshold for the duration of the designated predetermined time interval.

13. The method of claim 12, further comprising:
not activating a deal that corresponds to the offer for the one or more acceptances in response to determining that the number of the one or more acceptances is less than the threshold for the duration of the designated predetermined time interval.

14. The method of claim 7, further comprising:
specifying a period of time during which the second plurality of instances of the offer is to be provided; and
discontinuing the providing of the second plurality of instances of the offer in response to expiration of the period of time.

15. A system, comprising:
provision logic configured to provide a first plurality of instances of an offer that specifies a variable discount with respect to a price of at least one of a good or a service;
reduction logic configured to reduce an amount of the variable discount for each successive subset of the first plurality of instances, each subset including one or more instances of the first plurality of instances; and
determination logic configured to determine whether a number of a first plurality of acceptances of the offer reaches a first threshold, each of the first plurality of acceptances corresponding to a respective instance of the first plurality of instances,
the reduction logic further configured to discontinue reduction of the amount of the variable discount to provide a fixed discount in response to a determination that the number of the first plurality of acceptances reaches the first threshold,
the provision logic further configured to provide a second plurality of instances of the offer to specify the fixed discount with respect to the price of the at least one of the good or the service in response to discontinuation of the reduction of the amount of the variable discount.

16. The system of claim 15, further comprising:
activation logic configured to activate a deal that corresponds to the offer in response to the determination that the number of the first plurality of acceptances reaches the first threshold.

17. The system of claim 15, wherein the determination logic is further configured to determine whether a number of a second plurality of acceptances of the offer reaches a second threshold, each of the second plurality of acceptances corresponding to a respective instance of the second plurality of instances; and
wherein the provision logic is further configured to discontinue provision of the second plurality of instances in response to a determination that the number of the second plurality of acceptances reaches the second threshold.

18. The system of claim 15, wherein the determination logic is further configured to determine whether the number of the first plurality of acceptances is less than the first threshold for a designated period of time; and
wherein the provision logic is further configured to discontinue provision of the first plurality of instances of the offer in response to a determination that the number of the first plurality of acceptances is less than the first threshold for the designated period of time.

19. The system of claim 18, further comprising:
activation logic configured to not activate a deal, which corresponds to the offer, for the first plurality of acceptances in response to determining that the number of the first plurality of acceptances is less than the first threshold for the designated period of time.

20. The system of claim 15, wherein the provision logic is further configured to discontinue provision of the second plurality of instances of the offer in response to expiration of a specified period of time during which the second plurality of instances of the offer is to be provided.
